(19) United States
(12) Patent Application Publication
(10) Pub. No.: US 2024/0248833 A1
(43) Pub. Date: Jul. 25, 2024

(54) ALERTING AND REMEDIATING AGENTS AND MANAGED APPLIANCES IN A MULTI-CLOUD COMPUTING SYSTEM

(71) Applicant: VMware, Inc., Palo Alto, CA (US)

(72) Inventors: Prateek GUPTA, San Francisco, CA (US); Fnu YASHU, Sunnyvale, CA (US); Anru XU, San Jose, CA (US); Tracy LIANG, San Jose, CA (US)

(21) Appl. No.: 18/158,414

(22) Filed: Jan. 23, 2023

(51) Int. Cl. G06F 11/36

(52) U.S. Cl. CPC G06F 11/3664

(57) ABSTRACT

An example method of alerting and remediation in a multi-cloud computing system having a public cloud in communication with a data center includes: receiving, at remediation and troubleshooting software executing in the public cloud, event and log information generated by endpoint software executing in the data center during operation thereof; generating, at the remediation and troubleshooting software, an incident in response to the event and log information; sending, by a remediation and troubleshooting service (RTS) of the remediation and troubleshooting software in response to the incident, a remediation task to a coordinator agent over a message fabric, the coordinator agent executing in an agent platform appliance of the data center; and executing, by the coordinator agent, remediation of the endpoint software according to the remediation task.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by management software that communicates with virtualization software (e.g., hypervisor) installed in the host computers.

SDDC users move through various business cycles, requiring them to expand and contract SDDC resources to meet business needs. This leads users to employ multi-cloud solutions, such as typical hybrid cloud solutions where the SDDC spans across an on-premises data center and a public cloud. Running applications across multiple clouds can engender complexity in setup, management, and operations. Further, there is a need for centralized control and management of applications across the different clouds. With this centralized control and management, there is a need for remediation and troubleshooting services to collect information from components executing across different data centers, generate alerts from such information, and diagnose and remediate problems.

### SUMMARY

In an embodiment, a method of alerting and remediation in a multi-cloud computing system having a public cloud in communication with a data center is described. The method comprises: receiving, at remediation and troubleshooting software executing in the public cloud, event and log information generated by endpoint software executing in the data center during operation thereof; generating, at the remediation and troubleshooting software, an incident in response to the event and log information; sending, by a remediation and troubleshooting service (RTS) of the remediation and troubleshooting software in response to the incident, a remediation task to a coordinator agent over a message fabric, the coordinator agent executing in an agent platform appliance of the data center; and executing, by the coordinator agent, remediation of the endpoint software according to the remediation task.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 depicts a block diagram showing a cloud control plane implemented in a public cloud and an SDDC that is managed through the cloud control plane, according to embodiments.

FIG. 2 is a block diagram of an SDDC in which embodiments described herein may be implemented.

FIG. 3 is a block diagram depicting a portion of a remediation and troubleshooting platform related to alert processing according to embodiments.

FIG. 4 is a block diagram depicting a portion of a remediation and troubleshooting platform related to automatic remediation according to embodiments.

FIG. 5 is a block diagram depicting remote access to endpoint software by a cloud service according to embodiments.

FIG. 6 is a flow diagram depicting a method of alerting and remediation in a multi-cloud computing system according to an embodiment.

FIG. 7 is a flow diagram depicting a method of auto-remediation of incidents according to an embodiment.

### DETAILED DESCRIPTION

One or more embodiments employ a cloud control plane for managing the configuration of SDDCs, which may be of different types and which may be deployed across different geographical regions, according to a desired state of the SDDC defined in a declarative document referred to herein as a desired state document. The cloud control plane is responsible for generating the desired state and specifying configuration operations to be carried out in the SDDCs according to the desired state. Thereafter, configuration agents running locally in the SDDCs establish cloud inbound connections with the cloud control plane to acquire the desired state and the configuration operations to be carried out, and delegate the execution of these configuration operations to services running in a local SDDC control plane.

One or more embodiments provide a cloud platform from which various services, referred to herein as “cloud services,” are delivered to the SDDCs through agents of the cloud services that are running in an appliance (referred to herein as an “agent platform appliance”). A cloud platform hosts containers in which software components can execute, including cloud services and other services and databases as described herein. Cloud services are services provided from a public cloud to endpoint software executing in data centers such as the SDDCs. The agent platform appliance is deployed in the same customer environment, e.g., a private data center, as the management appliances of the SDDCs. In one embodiment, the cloud platform is provisioned in a public cloud and the agent platform appliance is provisioned as a virtual machine in the customer environment, and the two communicate over a public network, such as the Internet. In addition, the agent platform appliance and the management appliances communicate with each other over a private physical network, e.g., a local area network. In embodiments, the cloud services include at least one corresponding agent deployed on the agent platform appliance. All communication between the cloud services and the endpoint software of the SDDCs is carried out through the agent platform appliance using a messaging fabric, for example, through respective agents of the cloud services that are deployed on the agent platform appliance. The messaging fabric is software that exchanges messages between the cloud platform and agents in the agent platform appliance over the public network. The components of the messaging fabric are described below.

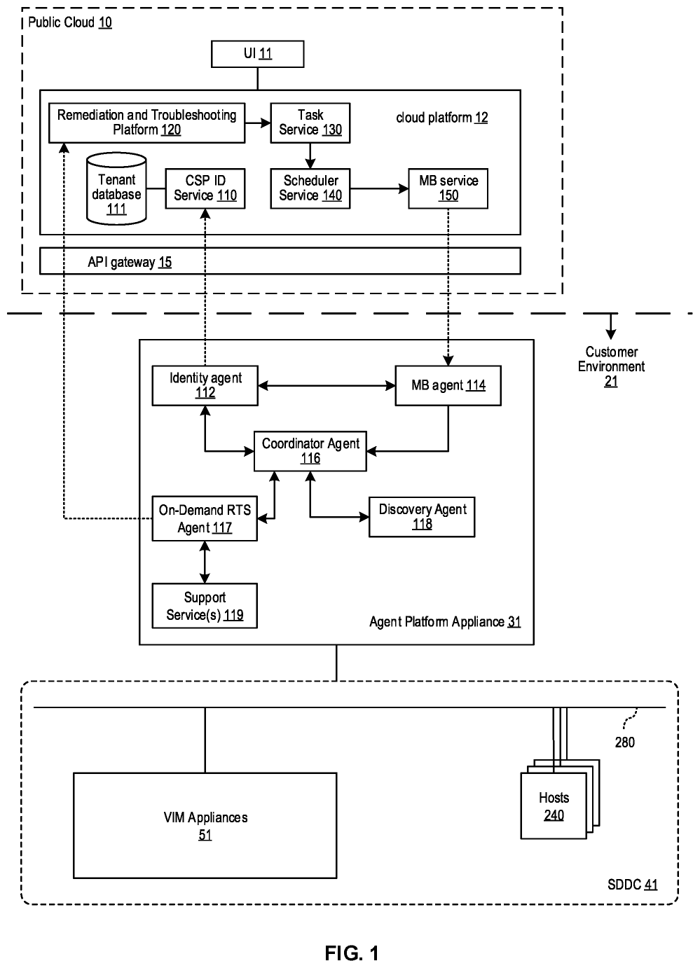

FIG. 1 is a block diagram of a customer environment 21 of an organization (hereinafter also referred to as a “customer” or a “tenant”) that is managed along with other tenants through a multi-tenant cloud platform 12, which is implemented in a public cloud 10. A user interface (UI) or an application programming interface (API) that interacts with cloud platform 12 is depicted in FIG. 1 as UI 11.

An SDDC is depicted in FIG. 1 in customer environment 21 and is a data center (SDDC 41) in communication with public cloud 10. In the customer environment, SDDC 41 is managed by virtual infrastructure management (VIM) appliances 51, e.g., VMware vCenter® server appliance and VMware NSX® server appliance. VIM appliances 51 in customer environment 21 communicate with an agent platform appliance 31, which hosts agents that communicate with cloud platform 12, e.g., via a messaging fabric over a public network, to deliver cloud services to customer environment 21. FIG. 1 shows only one customer environment 21 for purposes of clarity by example. VIM appliances 51 for managing SDDC 41 in customer environment 21 communicate with agent platform appliance 31. VIM appliances 51 are an example of endpoint software executing in a data center that is a target of a cloud service executing in public cloud 10. Endpoint software is software executing in SDDC 41 with which a cloud service can interact as described further herein.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, the agent platform appliance and the management appliances are VMs instantiated on one or more physical host computers (hosts 240) having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, the agent platform appliance and the management appliances may be implemented as physical host computers having the conventional hardware platform described above.

FIG. 1 illustrates components of cloud platform 12 and agent platform appliance 31. The components of cloud platform 12 include a number of different cloud services that enable each of a plurality of tenants that have registered with cloud platform 12 to manage its SDDCs through cloud platform 12. During registration for each tenant, the tenant's profile information, such as the URLs of the management appliances of its SDDCs, is collected, and user IDs and passwords for accessing (i.e., logging in to) cloud platform 12 through UI 11 are set up for the tenant. The user IDs and passwords are associated with various users of the tenant's organization who are assigned different roles. The tenant profile information is stored in tenant database 111, and login credentials for the tenants are managed according to conventional techniques, e.g., Active Directory® or LDAP (Lightweight Directory Access Protocol).

In one embodiment, each of the cloud services is a microservice that is implemented as one or more container images executed on a virtual infrastructure of public cloud 10. The cloud services include a cloud service provider (CSP) ID service 110, a task service 130, a scheduler service 140, and a message broker (MB) service 150. Cloud services further include a remediation and troubleshooting platform 120. Similarly, each of the agents deployed in agent platform appliance 31 is a microservice that is implemented as one or more container images executing in agent platform appliance 31.

CSP ID service 110 manages authentication of access to cloud platform 12 through UI 11 or through an API call made to one of the cloud services via API gateway 15. Access through UI 11 is authenticated if login credentials entered by the user are valid. API calls made to the cloud services via API gateway 15 are authenticated if they contain CSP access tokens issued by CSP ID service 110. Such CSP access tokens are issued by CSP ID service 110 in response to authenticated requests from identity agent 112. For example, before CSP ID service 110 issues an access token, identity agent 112 may sign a challenge phrase with a private key. Then, to verify the possession of the private key by identity agent 112, CSP ID service 110 may decrypt the signed challenge phrase using a corresponding public key.

In the embodiment, cloud services manage endpoint software in customer environment 21. For example, cloud services can include an entitlement service that entitles (applies a subscription entitlement to) VIM appliances and other software executing in customer environment 21. An entitlement service creates a task and makes an API call to task service 130 to perform the task (“entitlement task”). Task service 130 then schedules the task to be performed with scheduler service 140, which then creates a message containing the task to be performed and inserts the message in a message queue managed by MB service 150. After scheduling the task to be performed with scheduler service 140, task service 130 periodically polls scheduler service 140 for a status of the scheduled task. Similarly, remediation and troubleshooting platform 120 can create tasks and make calls to task service 130 to perform the tasks (“remediation tasks”). Task service 130 then schedules the remediation tasks to be performed with scheduler service 140, which then creates a message containing the task to be performed and inserts the message in the message queue.

At predetermined time intervals, MB agent 114, which is deployed in agent platform appliance 31, makes an API call to MB service 150 to exchange messages that are queued in their respective queues (not shown), i.e., to transmit to MB service 150 messages MB agent 114 has in its queue and to receive from MB service 150 messages MB service 150 has in its queue. MB service 150 implements a messaging fabric on behalf of cloud platform 12 over which messages are exchanged between cloud platform 12 (e.g., cloud services) and agent platform appliance 31 (e.g., coordinator agent 116). Agent platform appliance 31 can register with cloud platform 12 by executing MB agent 114 in communication with MB service 150.

Coordinator agent 116 is an agent that deploys other agents of agent platform appliance 31 and that manages the lifecycles thereof, including identity agent 112, MB agent 114, and discovery agent 118. According to embodiments, coordinator agent 116 deploys on-demand RTS agents to handle automatic remediation (“auto-remediation”) of incidents involving VIM appliances 51 and incidents involving agents of agent platform appliance 31. The on-demand RTS agents then communicate with remediation and troubleshooting platform 120 to report the results of the auto-remediation, as discussed further below. For simplicity, FIG. 1 only illustrates one on-demand RTS agent 117. The on-demand RTS agents communicate with VIM appliances 51 either through APIs of VIM appliances 51 or through support service(s) 119. For example, support service(s) 119 may include a secure shell daemon (SSHD) service. Discovery agent 118 is an agent that communicates with VIM appliances 51 to obtain authentication tokens for enabling other agents deployed in agent platform appliance 31 to access VIM appliances 51.

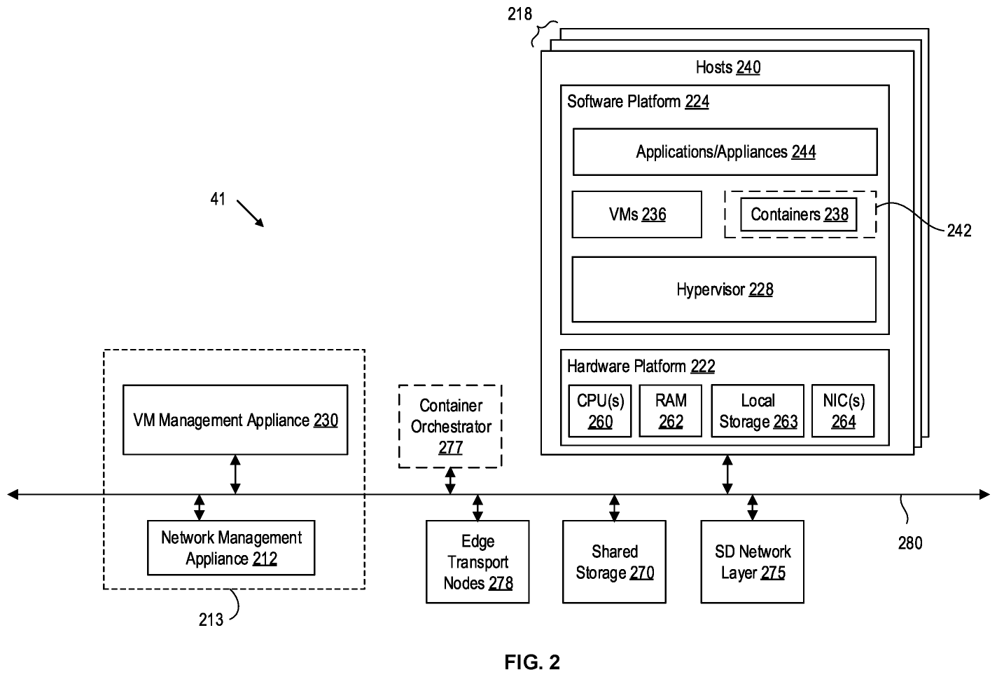

FIG. 2 is a block diagram of SDDC 41 in which embodiments described herein may be implemented. SDDC 41 includes a cluster of hosts 240 (“host cluster 218”) that may be constructed on hardware platforms such as an x86 architecture platforms. For purposes of clarity, only one host cluster 218 is shown. However, SDDC 41 can include many of such host clusters 218. As shown, a hardware platform 222 of each host 240 includes conventional components of a computing device, such as one or more central processing units (CPUs) 260, system memory (e.g., random access memory (RAM) 262), one or more network interface controllers (NICs) 264, and optionally local storage 263. CPU(s) 260 are configured to execute instructions, for example, executable instructions that perform one or more operations described herein, which may be stored in RAM 262. NIC(s) 264 enable host 240 to communicate with other devices through a physical network 280. Physical network 280 enables communication between hosts 240 and between other components and hosts 240 (other components discussed further herein).

In the embodiment illustrated in FIG. 2, hosts 240 access shared storage 270 by using NIC(s) 264 to connect to network 280. In another embodiment, each host 240 contains a host bus adapter (HBA) through which input/output operations (IOs) are sent to shared storage 270 over a separate network (e.g., a fibre channel (FC) network). Shared storage 270 includes one or more storage arrays, such as a storage area network (SAN), network attached storage (NAS), or the like. Shared storage 270 may comprise magnetic disks, solid-state disks, flash memory, and the like as well as combinations thereof. In some embodiments, hosts 240 include local storage 263 (e.g., hard disk drives, solid-state drives, etc.). Local storage 263 in each host 240 can be aggregated and provisioned as part of a virtual SAN, which is another form of shared storage 270.

A software platform 224 of each host 240 provides a virtuali ration layer, referred to herein as a hypervisor 228, which directly executes on hardware platform 222. In an embodiment, there is no intervening software, such as a host operating system (OS), between hypervisor 228 and hardware platform 222. Thus, hypervisor 22S is a Type-1 hypervisor (also known as a “bare-metal” hypervisor). As a result, the virtualization layer in host cluster 218 (collectively hypervisors 228) is a bare-metal virtualization layer executing directly on host hardware platforms. Hypervisor 228 abstracts processor, memory, storage, and network resources of hardware platform 222 to provide a virtual machine execution space within which multiple virtual machines (VMs) 236 may be concurrently instantiated and executed. Applications and/or appliances 244 execute in VMs 236 and/or containers 238 (discussed below).

Host cluster 218 is configured with a software-defined (SD) network layer 275. SD network layer 275 includes logical network services executing on virtualized infrastructure in host cluster 218. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, SDDC 41 includes edge transport nodes 278 that provide an interface of host cluster 218 to a wide area network (WAN) (e.g., a corporate network, the public Internet, etc.).

VM management appliance 230 (e.g., one of VIM appliances 51 and an example of endpoint software described herein) is a physical or virtual server that manages host cluster 218 and the virtualization layer therein. VM management appliance 230 installs agent(s) in hypervisor 228 to add a host 240 as a managed entity. VM management appliance 230 logically groups hosts 240 into host cluster 218 to provide cluster-level functions to hosts 240, such as VM migration between hosts 240 (e.g., for load balancing), distributed power management, dynamic VM placement according to affinity and anti-affinity rules, and high-availability. The number of hosts 240 in host cluster 218 may be one or many. VM management appliance 230 can manage more than one host cluster 218.

In an embodiment, SDDC 41 further includes a network management appliance 212 (e.g., another VIM appliance 51). Network management appliance 212 is a physical or virtual server that orchestrates SD network layer 275. In an embodiment, network management appliance 212 comprises one or more virtual servers deployed as VMs. Network management appliance 212 installs additional agents in hypervisor 228 to add a host 240 as a managed entity, referred to as a transport node. In this manner, host cluster 218 can be a cluster of transport nodes. One example of an SD networking platform that can be configured and used in embodiments described herein as network management appliance 212 and SD network layer 275 is a VMware NSX® platform made commercially available by VMware, Inc. of Palo Alto, CA.

VM management appliance 230 and network management appliance 212 comprise a virtual infrastructure (VI) control plane 213 of SDDC 41. VM management appliance 230 can include various VI services. The VI services include various virtualization management services, such as a distributed resource scheduler (DRS), high-availability (HA) service, single sign-on (SSO) service, virtualization management daemon, and the like. An SSO service, for example, can include a security token service, administration server, directory service, identity management service, and the like configured to implement an SSO platform for authenticating users.

In embodiments, SDDC 41 can include a container orchestrator 277. Container orchestrator 277 implements an orchestration control plane, such as Kubernetes®, to deploy and manage applications or services thereof on host cluster 218 using containers 238. In embodiments, hypervisor 228 can support containers 238 executing directly thereon. In other embodiments, containers 238 are deployed in VMs 236 or in specialized VMs referred to as “pod VMs 242.” A pod VM 242 is a VM that includes a kernel and container engine that supports execution of containers, as well as an agent (referred to as a pod VM agent) that cooperates with a controller executing in hypervisor 228 (referred to as a pod VM controller). Container orchestrator 277 can include one or more master servers configured to command and configure pod VM controllers in host cluster 218. Master server(s) can be physical computers attached to network 280 or VMs 236 in host cluster 218.

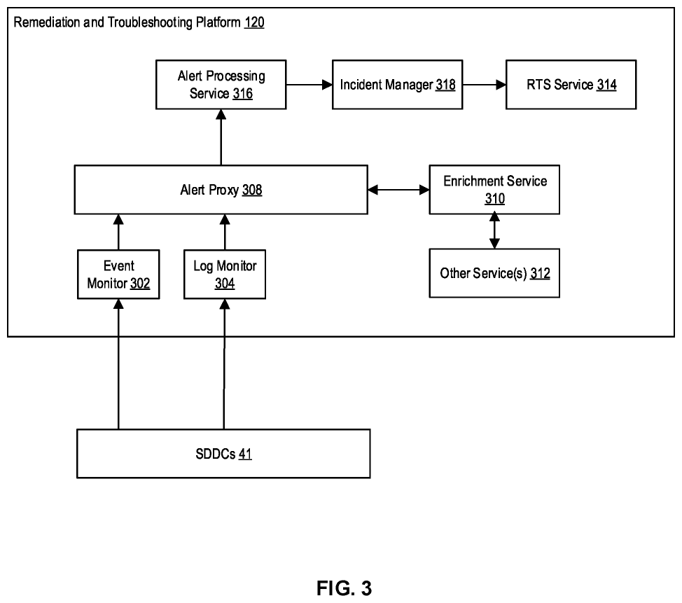

FIG. 3 is a block diagram depicting a portion of remediation and troubleshooting platform 120 related to alert processing according to embodiments. Remediation and troubleshooting platform 120 includes various data collection services including, for example, event monitor 302 and log monitor 304. Event monitor 302 is configured to monitor events generated by endpoint software in SDDCs 41, such as VIM appliances 51, and by agents executing in agent platform appliance 31. Log monitor 304 is configured to collect logs generated by endpoint software in SDDCs 41 and by agents in agent platform appliance 31. Event monitor 302 and log monitor 304 generate alerts in response to parsing the events and logs, respectively. Those skilled in the art will appreciate that other types of data collection and alert generating services can be employed in addition to or in place of event monitor 302 and/or log monitor 304.

Alert proxy 308 is configured to receive alerts generated by event monitor 302 and log monitor 304. Alert proxy 308 is configured to provide the alerts to enrichment service 310. Enrichment service 310 cooperates with other service(s) 312 to enrich the alerts with information related to infrastructure of SDDCs 41 and of agent platform appliance 31. Enrichment information comprises metadata added to the alerts related to the infrastructure. Enrichment information can include, for example, metadata related to a VIM appliance, metadata related to an agent platform appliance, and the like. Enrichment service 310 returns the alerts to alert proxy 308. Alert proxy 308 provides the alerts with the enrichment information to alert processing service 316.

Alert processing service 316 processes the input alerts against defined correlation patterns to create incidents. An incident can be generated in response to one or more alerts satisfying certain criteria or patterns. For example, the criteria or patterns may be a set of the same alerts received within a certain time period, a sequence of different alerts received in a certain order, an alert satisfying a certain threshold of severity, and any like number of a myriad of possible criteria. Alert processing service 316 provides incidents to incident manager 318. Incident manager 318 coordinates the incident process. Incident manager 318 can, for some incidents, call remediation and troubleshooting service (RTS) 314 to trigger an automatic remediation of the incidents (discussed further below). Incident manager 318 can generate tickets for incidents, which can be routed as configured by users (e.g., email generation, mobile message generation, etc.). RTS service 314 functions as described below.

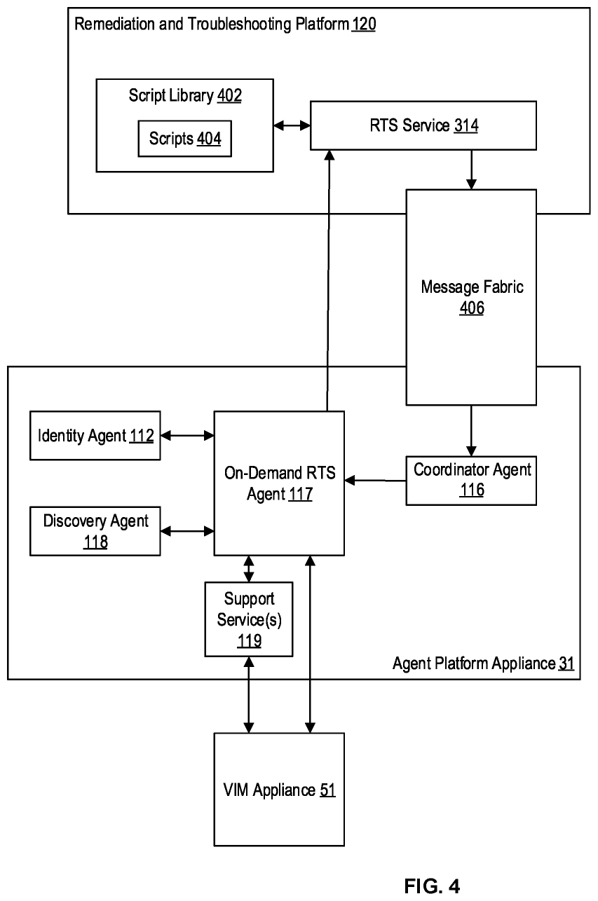

FIG. 4 is a block diagram depicting a portion of remediation and troubleshooting platform 120 related to automatic remediation according to embodiments. Remediation and troubleshooting platform 120 includes script library 402 configured to store scripts 404. Scripts 404 can be executable code, interpreted code, or the like configured to be executed by endpoint software or agents in response to related incidents. An incident can cause execution of one or more scripts 404 on the associated endpoint software or agent. In response to an incident, RTS service 314 sends a task to coordinator agent 116 through message fabric 406. The message also includes one or more of scripts 404 to be executed. Message fabric 406, as described in embodiments above, can include task service 130, scheduler service 140, MB service 150, and MB agent 114.

Coordinator agent 116, in response to an auto-remediation task, deploys on-demand RTS agent 117. Coordinator agent 116 can deploy an additional on-demand RTS agent for each auto-remediation task provided by RTS service 314. On-demand RTS agent 117 can cooperate with identity agent 112 and/or discovery agent 118 to obtain login information (user, group, etc.) and credentials for accessing the endpoint software or agent. In embodiments, on-demand RTS agent 117 can execute script(s) 404 by calling an API of the endpoint software or agent. In embodiments, on-demand RTS agent 117 can interact with the endpoint software through support service(s) 119 (e.g., an SSHD service). On-demand RTS agent 117 can report results back to RTS service 314 of the script execution (e.g., success, failure, etc.).

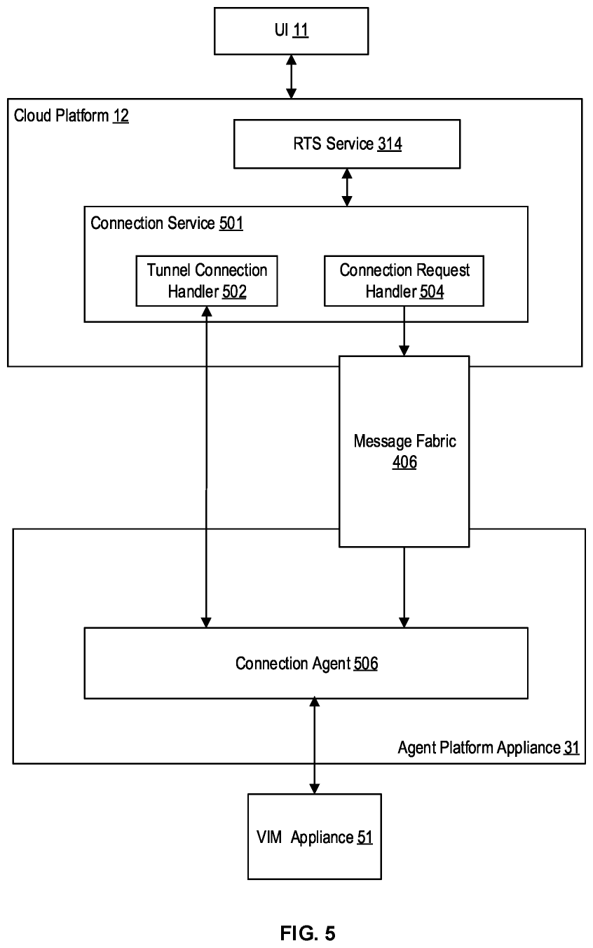

FIG. 5 is a block diagram depicting remote access to endpoint software by a cloud service according to embodiments. In some embodiments, incident manager 318 can identify an incident that requires user interaction and is not capable of auto-remediation. Alternatively, auto-remediation of an incident can fail, requiring human interaction. Incident manager 318 generates tickets for such incidents that are routed to the user. The user can then initiate remote access to the endpoint software in order to perform the remediation. RTS service 314 facilitates the connection to the endpoint software.

Connection service 501 includes a tunnel connection handler 502 and a connection request handler 504. Connection request handler 504 interfaces with message fabric 406 to send a connection task to a connection agent 506 in agent platform appliance 31 in response to a request from RTS service 314. Tunnel connection handler 502 includes local connections with UI 11 using the designated protocols and ports. Tunnel connection handler 502 establishes connection with connection agent 506, such as a web-socket connection over the Internet. Connection agent 506 cooperates with VIM appliance 51 to prepare VIM appliance 51 for the connection and establishes a local connection with VIM appliance 51. UI 11 communicates with VIM appliance 51 over the tunnel established by connection service 501 and connection agent 506. For example, the user can ssh into VIM appliance 51 over the web tunnel to execute scripts, commands, etc. in order to perform remediation in response to the incident for the ticket(s) that were generated.

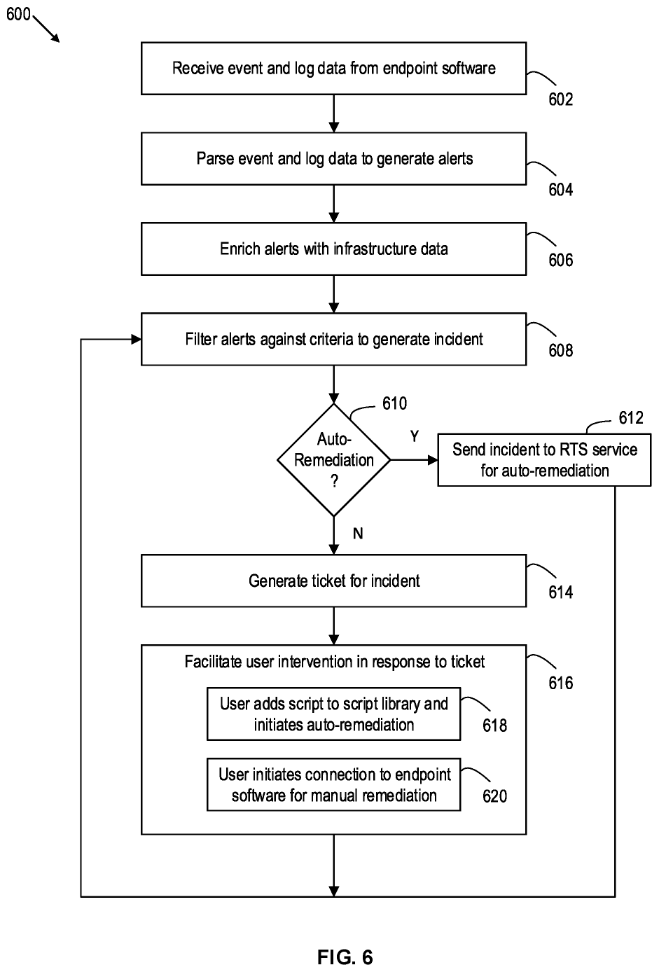

FIG. 6 is a flow diagram depicting a method 600 of alerting and remediation in a multi-cloud computing system according to an embodiment. Method 600 begins at step 602, where remediation and troubleshooting platform 120 receives event and log data from endpoint software (e.g., a VIM appliance 51) or an agent in agent platform appliance 31. Event and log data is data generated by the endpoint software or agent during its execution. Event and log data can include events generated by the endpoint software or agent, logs generated by the endpoint software or agent, metrics generated by the endpoint software or agent, and the like during its operation. Remediation and troubleshooting platform 120 can include one or more services to collect the event and log information (e.g., event monitor 302, log monitor 304, and the like).

At step 604, remediation and troubleshooting platform 120 parses the event and log data to generate alerts. The endpoint software or agent can indicate in the event and log data various warnings, errors, informational notices, and the like regarding its operation. Remediation and troubleshooting platform 120 analyzes the event and log information and extracts alerts indicative of warnings, errors, or other indications of undesirable operation of the endpoint software or agent. At step 606, remediation and troubleshooting platform 120 enriches the alerts with infrastructure data (e.g., via enrichment service 310 in cooperation with other service(s) 312). The enrichment information adds metadata related to the infrastructure (e.g., VIM appliance metadata, agent platform appliance metadata, and the like).

At step 608, remediation and troubleshooting platform 120 filters the alerts against defined criteria to generate an incident. Various criteria are described above with respect to operation of alert processing service 316. At step 610, remediation and troubleshooting platform 120 determines if auto-remediation can be performed. If so, method 600 proceeds to step 612, where RTS service 314 performs the auto-remediation of the incident. Otherwise, method 600 proceeds to step 614, where remediation and troubleshooting platform 120 generates a ticket for the incident. Incident manager 318 can be configured with information to identify which incidents are candidates for auto-remediation and which incidents must be ticketed for user interaction. In some cases, remediation and troubleshooting platform 120 may have attempted to auto-remediate an incident without success. In such case, incident manager 318 can generate a ticket for the incident including the failure of auto-remediation and the requirement for user interaction.

At step 616, remediation and troubleshooting platform 120 facilitates user interaction in response to the ticket. In an embodiment, at step 618, the user adds a script 404 to script library 402 and initiates remediation for the incident. Alternatively, or in addition to step 618, at step 620, the user initiates a connection to the endpoint software or agent to perform manual remediation. The method returns to step 608 and repeats for each incident.

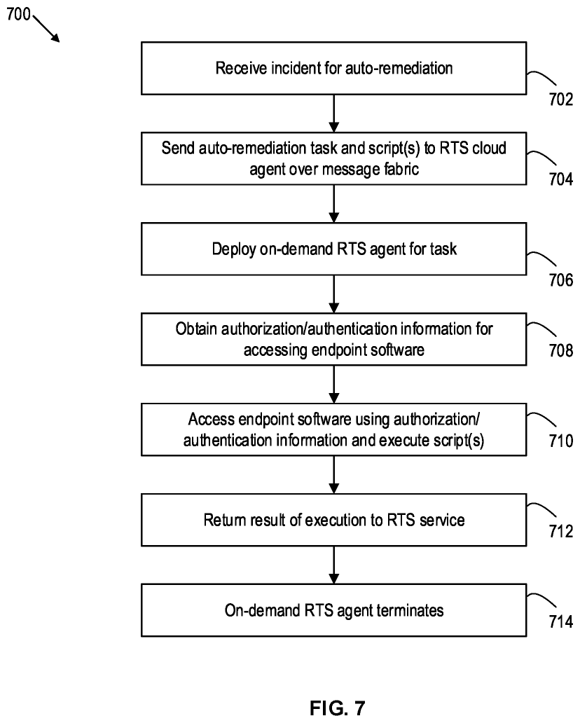

FIG. 7 is a flow diagram depicting a method 700 of auto-remediation of incidents according to an embodiment. Method 700 begins at step 702, where RTS service 314 receives an incident for auto-remediation from incident manager 318. At step 704, RTS service 314 sends an auto-remediation task to coordinator agent 116 executing in agent platform appliance 31 of SDDC 41 over message fabric 406. RTS service 314 also sends to coordinator agent 116, script(s) 404 corresponding to the auto-remediation task, to be executed on the endpoint software or agent. At step 706, coordinator agent 116 deploys on-demand RTS agent 117 to handle the task. At step 708, on-demand RTS agent 117 obtains authorization/authentication information for accessing the endpoint software or agent. Authorization/authentication information comprises any information needed to make a connection to the endpoint software or agent. Examples include usernames, credentials, and the like.

At step 710, on-demand RTS agent 117 accesses the endpoint software or agent using the authorization/authentication information and executes the script(s). Each script can include any sequence of operations to be performed by the endpoint software or agent. For example, a script can include a sequence of API calls to a defined API of the endpoint software or agent (e.g., accessed using a known port and protocol). In another example, a script can be executable code or interpreted code to be executed/interpreted by the endpoint software or agent. The script can be provided through an API of the endpoint software or agent or using a supporting service, such as ssh. At step 712, on-demand RTS agent 117 returns the result of the script execution to RTS service 314. At step 714, on-demand RTS agent 117 terminates.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of alerting and remediation in a multi-cloud computing system having a public cloud in communication with a data center, the method comprising:
receiving, at remediation and troubleshooting software executing in the public cloud, event and log information generated by endpoint software executing in the data center during operation thereof;
generating, at the remediation and troubleshooting software, an incident in response to the event and log information;
sending, by a remediation and troubleshooting service (RTS) of the remediation and troubleshooting software in response to the incident, a remediation task to a coordinator agent over a message fabric, the coordinator agent executing in an agent platform appliance of the data center; and
executing, by the coordinator agent, remediation of the endpoint software according to the remediation task.

2. The method of claim 1, wherein the step of generating the incident comprises:
parsing the event and log information to generate alerts; and
filtering the alerts against criteria to generate the incident.

3. The method of claim 2, further comprising:
enriching the alerts with metadata describing infrastructure of the data center prior to the step of filtering.

4. The method of claim 1, wherein the step of executing comprises:
deploying, by the coordinator agent, an on-demand RTS agent executing in the agent platform appliance for handling the remediation task; and
accessing the endpoint software by the on-demand RTS agent to execute at least one script corresponding to the remediation task.

5. The method of claim 4, further comprising:
obtaining, by the on-demand RTS agent, authorization/authentication information from at least one service executing in the agent platform appliance;
wherein the on-demand RTS agent accesses the endpoint software using the authorization/authentication information.

6. The method of claim 4, wherein the on-demand RTS agent accesses the endpoint software through an application programming interface (API) of the endpoint software.

7. The method of claim 4, wherein the on-demand RTS agent accesses the endpoint software through a support service executing in the agent platform appliance.

8. A non-transitory computer readable medium comprising instructions to be executed in a computing device to cause the computing device to carry out a method of alerting and remediation in a multi-cloud computing system having a public cloud in communication with a data center, the method comprising:
receiving, at remediation and troubleshooting software executing in the public cloud, event and log information generated by endpoint software executing in the data center during operation thereof;
generating, at the remediation and troubleshooting software, an incident in response to the event and log information;
sending, by a remediation and troubleshooting service (RTS) of the remediation and troubleshooting software in response to the incident, a remediation task to a coordinator agent over a message fabric, the coordinator agent executing in an agent platform appliance of the data center; and
executing, by the coordinator agent, remediation of the endpoint software according to the remediation task.

9. The non-transitory computer readable medium of claim 8, wherein the step of generating the incident comprises:
parsing the event and log information to generate alerts; and
filtering the alerts against criteria to generate the incident.

10. The non-transitory computer readable medium of claim 9, further comprising:
enriching the alerts with metadata describing infrastructure of the data center prior to the step of filtering.

11. The non-transitory computer readable medium of claim 8, wherein the step of executing comprises:
deploying, by the coordinator agent, an on-demand RTS agent executing in the agent platform appliance for handling the remediation task; and
accessing the endpoint software by the on-demand RTS agent to execute at least one script corresponding to the remediation task.

12. The non-transitory computer readable medium of claim 11, further comprising:
obtaining, by the on-demand RTS agent, authorization/authentication information from at least one service executing in the agent platform appliance;
wherein the on-demand RTS agent accesses the endpoint software using the authorization/authentication information.

13. The non-transitory computer readable medium of claim 11 wherein the on-demand RTS agent accesses the endpoint software through an application programming interface (API) of the endpoint software.

14. The non-transitory computer readable medium of claim 11, wherein the on-demand RTS agent accesses the endpoint software through a support service executing in the agent platform appliance.

15. A multi-cloud computing system, comprising:
a public cloud in communication with a data center through a messaging fabric;
remediation and troubleshooting software executing in the public cloud; and
a coordinator agent executing in an agent platform appliance of the data center;
wherein the remediation and troubleshooting software is configured to:
receive event and log information generated by endpoint software executing in the data center during operation thereof;
generate an incident in response to the event and log information;
send, by a remediation and troubleshooting service (RTS) of the remediation and troubleshooting software in response to the incident, a remediation task to the coordinator agent over a message fabric; and
wherein the coordinator agent is configured to execute remediation of the endpoint software according to the remediation task.

16. The multi-cloud computing system of claim 15, wherein the remediation and troubleshooting software generates the incident by:
parsing the event and log information to generate alerts; and
filtering the alerts against criteria to generate the incident.

17. The multi-cloud computing system of claim 16, wherein the remediation and troubleshooting software is configured to:
enrich the alerts with metadata describing infrastructure of the data center prior to the step of filtering.

18. The multi-cloud computing system of claim 16, wherein the coordinator agent executes the remediation by:
deploying, by the coordinator agent, an on-demand RTS agent executing in the agent platform appliance for handling the remediation task; and
accessing the endpoint software by the on-demand RTS agent to execute at least one script corresponding to the remediation task.

19. The multi-cloud computing system of claim 18, wherein the on-demand RTS agent is configured to:
obtain authorization/authentication information from at least one service executing in the agent platform appliance;
wherein the on-demand RTS agent accesses the endpoint software using the authorization/authentication information.

20. The multi-cloud computing system of claim 18, wherein the on-demand RTS agent accesses the endpoint software through a support service executing in the agent platform appliance.
